(19) United States
(12) Patent Application Publication
(10) Pub. No.: US 2022/0038532 A1
(43) Pub. Date: Feb. 3, 2022

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventors: Ryuichi HORIGANE, Kanagawa (JP); Rahul ARUNA PUGALENDHI, Kanagawa (JP)

(73) Assignee: FUJIFILM BUSINESS INNOVATION CORP., Tokyo (JP)

(21) Appl. No.: 17/164,922

(22) Filed: Feb. 2, 2021

(30) Foreign Application Priority Data
Jul. 29, 2020 (JP) 2020-128277

(51) Int. Cl. H04L 29/08; H04L 29/06

(52) U.S. Cl. CPC H04L 67/1023; H04L 67/1012; H04L 67/1008; H04L 67/22; H04L 67/42; H04L 67/40; H04L 67/32

(57) ABSTRACT

An information processing apparatus includes a processor configured to switch a communication interface used for communication with a communication partner, in which data to be acquired is stored, in accordance with a state of the information processing apparatus in a case where a first communication interface, which is an asynchronous communication interface that notifies the information processing apparatus about a change made to the data every time the data is changed, and a second communication interface, which is a synchronous communication interface that collectively notifies the information processing apparatus about plural changes made to the data, are prepared in the communication partner.

### CROSS-REFERENCE TO RELATED APPLICATIONS

This application is based on and claims priority under 35 USC 119 from Japanese Patent Application No. 2020-128277 filed Jul. 29, 2020.

### BACKGROUND

### (i) Technical Field

The present disclosure relates to an information processing apparatus and a non-transitory computer readable medium.

### (ii) Related Art

A system that offers a service through cooperation among plural clients and a single server is known. In this system, a frequency of use of the server is monitored for each client, and when a load on the server increases, a reduction in load on the server is sometimes attempted by stopping use of a client whose use frequency is low.

See, for example, Japanese Unexamined Patent Application Publication No. 8-272723.

### SUMMARY

In a system that offers a service through cooperation among plural clients and a server, a load on the server is reduced in a case where use of a client (hereinafter also referred to as a “user”) whose use frequency is relatively low as compared with other clients is stopped, but data consistency with the server is temporarily lost as for the client whose use has been stopped. This impairs usability.

Aspects of non-limiting embodiments of the present disclosure relate to achieving both data consistency and a reduction in load in a system that offers a service through cooperation among a server and plural clients, as compared with a case where use of a user of a certain client is stopped.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to switch a communication interface used for communication with a communication partner, in which data to be acquired is stored, in accordance with a state of the information processing apparatus in a case where a first communication interface, which is an asynchronous communication interface that notifies the information processing apparatus about a change made to the data every time the data is changed, and a second communication interface, which is a synchronous communication interface that collectively notifies the information processing apparatus about plural changes made to the data, are prepared in the communication partner.

### BRIEF DESCRIPTION OF THE DRAWINGS

Exemplary embodiments of the present disclosure will be described in detail based on the following figures, wherein:

FIG. 1 illustrates an example of a configuration of a client-server-type network system;

FIG. 2 is a view for explaining an example of a configuration of a server used in a first exemplary embodiment;

FIG. 3 is a view for explaining an example of a configuration of a client terminal used in the first exemplary embodiment;

FIG. 4 is a view for explaining some of functions offered by a processor;

FIG. 5 is a flowchart for explaining an example of processing operation of a user API determining unit used in the first exemplary embodiment;

FIG. 6 is a view for explaining an example of a communication sequence using a synchronous API;

FIG. 7 is a view for explaining an example of a communication sequence using an asynchronous API;

FIGS. 8A through 8C illustrate an example of description of data transmitted from the server to the client terminal, FIG. 8A illustrates an example of the data in a case where a change is made by insertion of data, FIG. 8B illustrates an example of the data in a case where a change is made by update of data, and FIG. 8C illustrates an example of the data in a case where a change is made by deletion of data;

FIG. 9 is a view for explaining an example of a communication sequence after switching to the synchronous API;

FIG. 10 is a view for explaining an example of a communication sequence immediately after switching to the asynchronous API;

FIG. 11 is a view for explaining another example of a communication sequence immediately after switching to the asynchronous API;

FIG. 12 is a flowchart for explaining an example of processing operation of a user API determining unit used in a second exemplary embodiment;

FIG. 13 is a flowchart for explaining another example of processing operation of the user API determining unit used in the second exemplary embodiment;

FIG. 14 is a flowchart for explaining an example of processing operation of a user API determining unit used in a third exemplary embodiment;

FIG. 15 is a flowchart for explaining another example of processing operation of the user API determining unit used in the third exemplary embodiment;

FIG. 16 is a flowchart for explaining an example of processing operation of a user API determining unit used in a fourth exemplary embodiment; and

FIG. 17 is a flowchart for explaining another example of processing operation of the user API determining unit used in the fourth exemplary embodiment.

### DETAILED DESCRIPTION

Exemplary embodiments are described in detail below with reference to the attached drawings.

### First Exemplary Embodiment

### System Configuration

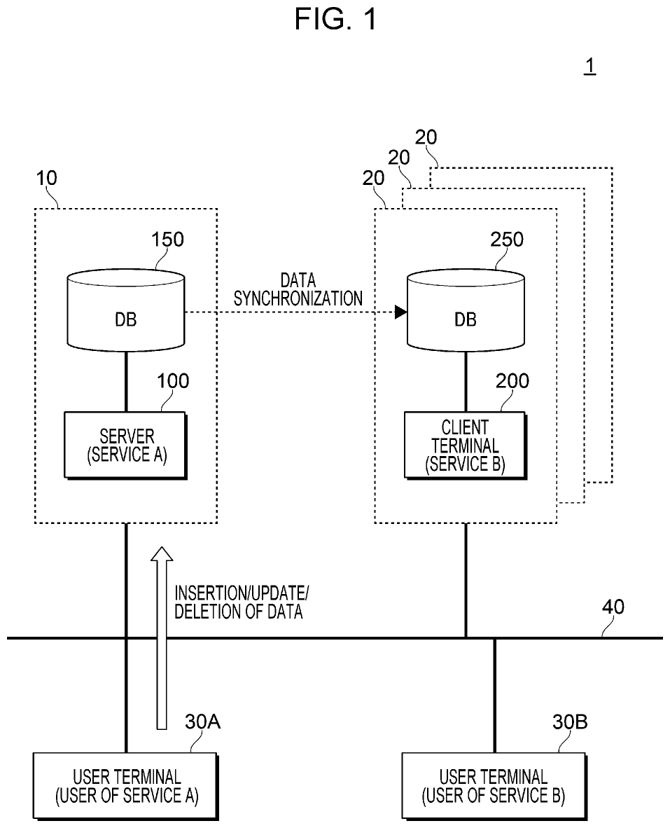

FIG. 1 illustrates an example of a configuration of a client-server-type network system 1.

The network system 1 illustrated in FIG. 1 includes a server system 10, a client system 20, a user terminal 30A that uses the server system 10, a user terminal 30B that uses the client system 20, and a network 40 connecting these members.

The network system 1 illustrated in FIG. 1 includes plural client systems 20. Note, however, that the network system 1 illustrated in FIG. 1 may include a single client system 20.

The server system 10 includes a server 100 and a database 150. The server 100 realizes some sort of function by offering data stored in the database 150 to the client system 20. In the present exemplary embodiment, this function is referred to as a “service A”.

The client system 20 includes a client terminal 200 and a database 250. The client terminal 200 realizes some sort of function by synchronizing data in the database 250 with the data in the database 150. In the present exemplary embodiment, this function is referred to as a “service B”.

In the database 150 of the server system 10, data is inserted, updated, or deleted by the user terminal 30A or an external system (not illustrated). The database 150 is changed by the insertion, update, or deletion.

The client system 20 is connected to the server system 10 over the network 40, and acquires data from the database 150 and reflects the data in the database 250. That is, the database 250 of the client system 20 is synchronized with the database 150 of the server system 10.

In the server 100 according to the present exemplary embodiment, a synchronous Application Programming Interface (API) and an asynchronous API are prepared. That is, the client terminal 200 communicates with the server 100 by using any one of these APIs.

In the present exemplary embodiment, an API used for communication is switched for each user using the user terminal 30B. An instruction concerning an API used for communication is given to the server 100 by the client terminal 200.

The user terminals 30A and 30B are terminals connected to the network 40 and are, for example, computers, smartphones, tablet terminals, or wearable terminals.

The network 40 is, for example, a local area network (LAN) or the Internet. The network 40 may be a wireless network or may be a wired network.

The server system 10 and the client system 20 according to the present exemplary embodiment may be run by the same business operator or may be run by different business operators.

The server system 10 and the client system 20 may be on-premise systems or may be cloud systems.

### Configurations of Devices

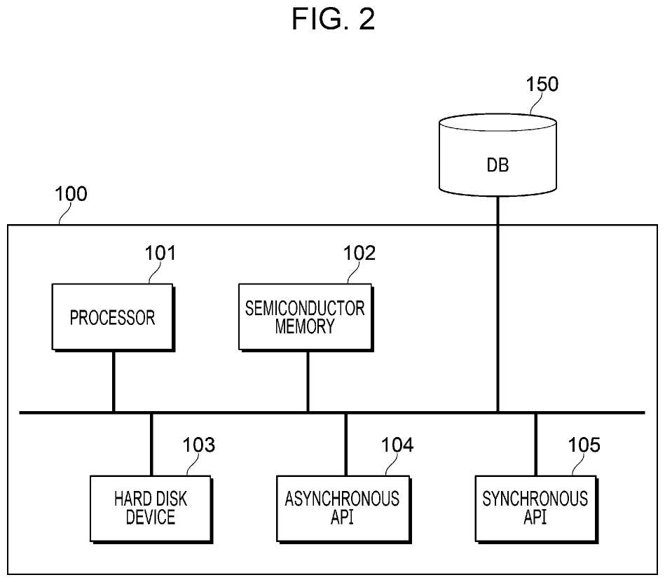

FIG. 2 is a view for explaining an example of a configuration of the server 100 used in the first exemplary embodiment.

The server 100 includes a processor 101 that controls operation of the whole device, a semiconductor memory 102, a hard disk device 103, an asynchronous API 104, and a synchronous API 105, which are connected through a signal line or a bus.

The processor 101 realizes various services through data processing.

The semiconductor memory 102 includes, for example, a read only memory (ROM) in which a Basic Input Output System (BIOS) is stored and a random access memory (RAM) used as a work area. The semiconductor memory 102 is an example of a storage device.

The processor 101 and the semiconductor memory 102 constitute a computer.

The hard disk device 103 is, for example, a non-volatile storage device in which basic software and an application program are stored. Note that a large-capacity semiconductor memory may be used instead of the hard disk device 103. The hard disk device 103 is also an example of a storage device.

The asynchronous API 104 is an interface that notifies the client terminal 200 about contents of a change made to the database 150 every time the database 150 is changed. Examples of the change include insertion, update, and deletion of data in the database 150. In communication using the asynchronous API 104, a change of data in the database 150 is instantly reflected in the database 250. In other words, communication using the asynchronous API 104 has instantaneousness. The asynchronous API 104 is an example of a first communication interface.

The synchronous API 105 is an interface that collectively notifies the client terminal 200 about plural changes made to the database 150. Communication using the synchronous API 105 is executed in response to a request from the client terminal 200. Accordingly, even in a case where a change is made to the database 150, the client terminal 200 is not notified about contents of the change until a request for synchronization is made by the client terminal 200, and when the request is made, the client terminal 200 is collectively notified about plural changes made after a previous request. A load on the server 100 is reduced by communication using the synchronous API 105. The synchronous API 105 is an example of a second communication interface.

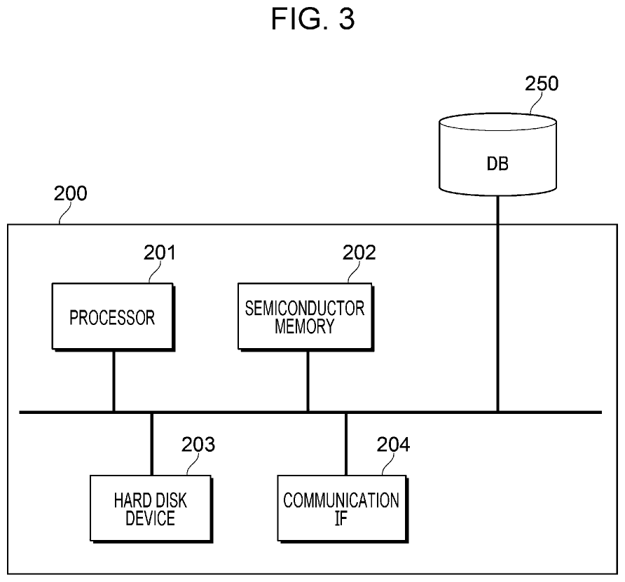

FIG. 3 is a view for explaining an example of a configuration of the client terminal 200 used in the first exemplary embodiment.

The client terminal 200 has a processor 201 that controls operation of the whole device, a semiconductor memory 202, a hard disk device 203, and a communication interface (hereinafter referred to as a “communication IF”) 204, which are connected through a signal line or a bus.

The processor 201 realizes various services through data processing.

The semiconductor memory 202 includes, for example, a ROM in which a BIOS is stored and a RAM used as a work area. The semiconductor memory 202 is an example of a storage device.

The processor 201 and the semiconductor memory 202 constitute a computer.

The hard disk device 203 is, for example, a non-volatile storage device in which basic software and an application program are stored. Note that a large-capacity semiconductor memory may be used instead of the hard disk device 203. The hard disk device 203 is also an example of a storage device.

The communication IF 204 communicates with the server 100 (see FIG. 1) over the network 40.

The client terminal 200 according to the present exemplary embodiment is an example of an information processing apparatus.

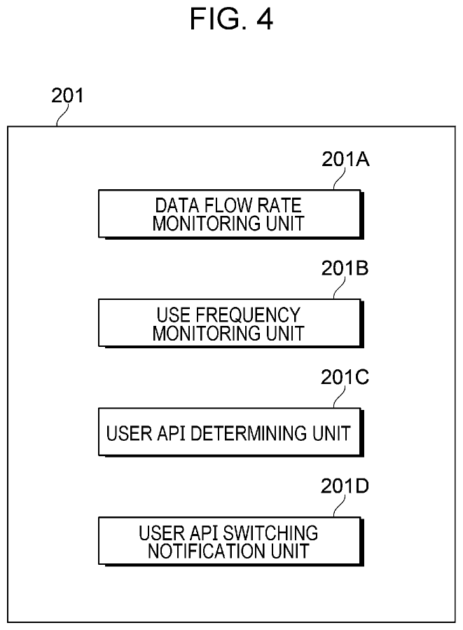

FIG. 4 is a view for explaining some of functions offered by the processor 201. FIG. 4 illustrates, as some of functions offered by the processor 201, a data flow rate monitoring unit 201A, a use frequency monitoring unit 201B, a user API determining unit 201C, and a user API switching notification unit 201D. These functions are realized through execution of programs by the processor 201.

The data flow rate monitoring unit 201A measures, for each user using the service B, an amount of data (hereinafter referred to as a “data flow amount”) that flows from the server 100 (see FIG. 1) to the client terminal 200 (see FIG. 1) per unit time. That is, the data flow rate monitoring unit 201A measures, for each user, a rate (hereinafter referred to as a “data rate”) at which data flows into the client terminal 200. The unit is, for example, megabytes per second.

The use frequency monitoring unit 201B measures a frequency of use (hereinafter referred to as a “use frequency”) of each user using the service B. In the present exemplary embodiment, it is assumed that the use frequency is the number of accesses to the client terminal 200 (see FIG. 1) per unit time. The unit is, for example, accesses per second.

The user API determining unit 201C determines an API used for communication with the server system 10 (see FIG. 1) in accordance with a status of communication of each user of the service B. To determine an API used for communication with the server system 10, the user API determining unit 201C uses both of or any one of the data rate and the use frequency as the status of communication of a user's terminal.

The user API determining unit 201C according to the present exemplary embodiment selects communication using the synchronous API as for a user whose data flow rate is higher than a threshold value and as for a user whose use frequency is lower than a threshold value and selects communication using the asynchronous API as for other users.

By using communication using the synchronous API as for a user whose data flow rate is higher than the threshold value, a reduction in load on the server 100 is attempted.

A user whose use frequency is low uses data in the database 250 not that often, and therefore influence on the offered service is small even if a change made to the database 150 is not instantly reflected in the database 250.

In view of this, in the present exemplary embodiment, the synchronous API is used for communication of a user whose use frequency is low from the perspective of balance between the load and instantaneousness. Furthermore, by using communication using the synchronous API as communication of a user whose use frequency is lower than a threshold value, a load on the while system can be lessened.

The user API switching notification unit 201D notifies the server 100 about switching of an API used for communication in a case where an API used for communication with the server 100 is changed.

In a case where the communication is switched from communication using the synchronous API to communication using the asynchronous API, the user API switching notification unit 201D transmits a request for registration of use of the asynchronous API to the server 100.

In a case where the user API switching notification unit 201D requests registration of use of the asynchronous API, the user API switching notification unit 201D requests, only one time, the server 100 to transmit changes of data that occur in the database 150 between last communication using the synchronous API and a current time.

In a case where communication is switched to the asynchronous API, next communication from the server 100 is limited to a case where a change is made to data in the database 150. Accordingly, even in a case where data is changed between last communication using the synchronous API and registration of use of the asynchronous API, the client terminal 200 is not notified about this change. As a result, data consistency between the database 150 and the database 250 is impaired. In view of this, the user API switching notification unit 201D according to the present exemplary embodiment requests the server 100 to transmit changes that occur in the database 150 between last communication using the synchronous API and a current time when requesting registration of use of the asynchronous API.

However, in a case where a change is made to data in the database 150 immediately after switching to the communication using the asynchronous API, duplicated data are transmitted to the client terminal 200. In view of this, upon detection of duplicated data, the processor 201 deletes any one of the data.

In a case where communication is switched from communication using the asynchronous API to communication using the synchronous API, the user API switching notification unit 201D transmits a request for deregistration of use of the asynchronous API to the server 100.

### Processing Operation

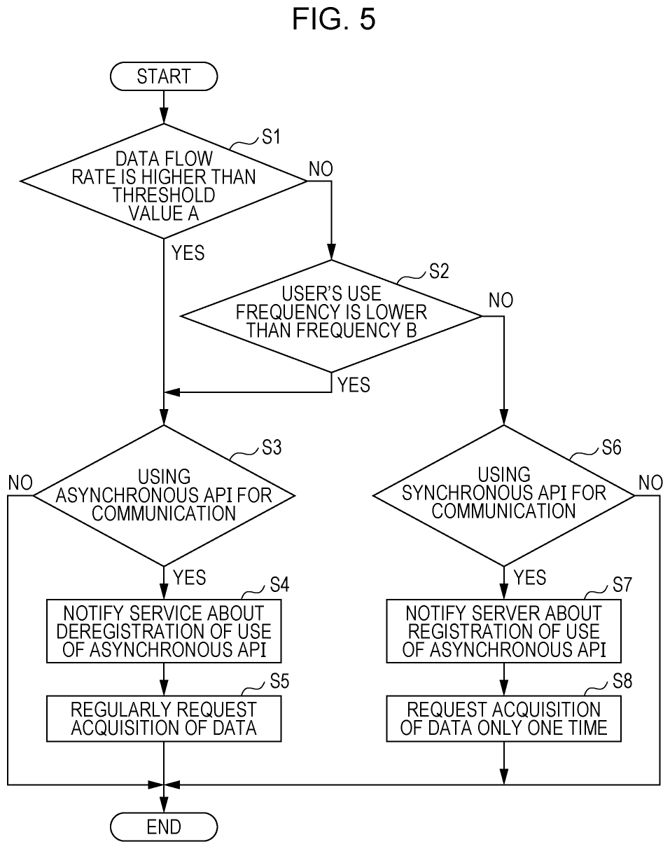

FIG. 5 is a flowchart for explaining an example of processing operation of the user API determining unit 201C (see FIG. 4) used in the first exemplary embodiment. In FIG. 5, the symbol “S” represents a step.

In the present exemplary embodiment, initially, the asynchronous API is used for communication of all users. The processing operation illustrated in FIG. 5 is executed for each user using the service B.

First, the user API determining unit 201C determines whether or not a data flow rate is higher than a threshold value A (step 1). The threshold value A is an example of a first threshold value.

In a case where a negative result is obtained in step 1, that is, in a case where the data flow rate is equal to or lower than the threshold value A, the user API determining unit 201C determines whether or not user's use frequency is lower than a threshold value B (step 2). The threshold value B is an example of a seventh threshold value.

In a case where a positive result is obtained in step 1 or in a case where a positive result is obtained in step 2, the user API determining unit 201C decides to use the synchronous API for communication of the user.

However, switching of the API is unnecessary in a case where the synchronous API is being used. Therefore, in a case where a positive result is obtained in step 1 or in a case where a positive result is obtained in step 2, the user API determining unit 201C determines whether or not the user is using the asynchronous API for communication (step 3).

In a case where a negative result is obtained in step 3, the user API determining unit 201C finishes this processing operation and prepares for next determination. The processing operation illustrated in FIG. 5 is repeatedly executed.

Meanwhile, in a case where a positive result is obtained in step 3, the user API switching notification unit 201D notifies the server 100 (see FIG. 1) about deregistration of use of the asynchronous API (step 4). Thereafter, the synchronous API is used for communication of the user.

Then, the processor 201 regularly requests the server 100 to acquire data (step 5).

In a case where a negative result is obtained in step 2, the user API determining unit 201C decides to use the asynchronous API for communication of the user.

However, switching of the API is unnecessary in a case where the asynchronous API is being used for communication. Therefore, in a case where a negative result is obtained in step 2, the user API determining unit 201C determines whether or not the user is using the synchronous API for communication (step 6).

In a case where a negative result is obtained in step 6, the user API determining unit 201C finishes this processing operation and prepares for next determination. The processing operation illustrated in FIG. 5 is repeatedly executed.

Meanwhile, in a case where a positive result is obtained in step 6, the user API switching notification unit 201D notifies the server 100 about registration of use of the asynchronous API (step 7). Thereafter, the asynchronous API is used for communication of the user.

Then, the user API switching notification unit 201D requests the server 100 to acquire data only one time (step 8). This is to prevent missing of data, as described above. Example of Communication Sequence

### Communication Sequence Using Synchronous API

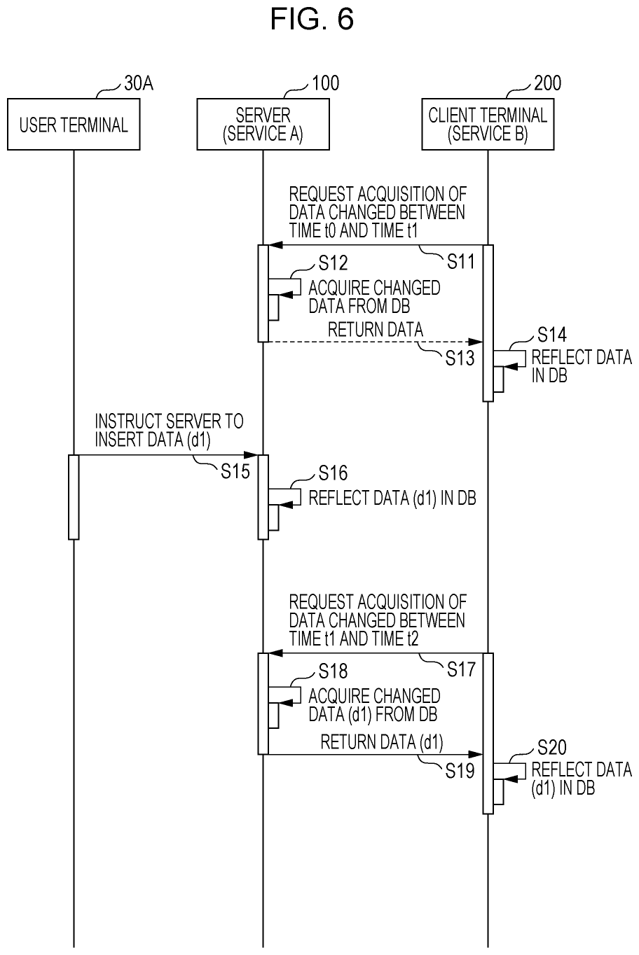

FIG. 6 is a view for explaining an example of a communication sequence using the synchronous API. FIG. 6 illustrates communication among the user terminal 30A using the service A, the server 100 that offers the service A, and the client terminal 200 that offers the service B. In FIG. 6, the symbol “S” represents a step.

Since FIG. 6 illustrates communication using the synchronous API, the client terminal 200 requests the server 100 to acquire data changed between a time t0 and a time t1 (step 11). The time t1 is a current time at which the client terminal 200 transmits the request. This request for data is regularly made.

This request is made for the purpose of synchronizing the data in the database 250 (see FIG. 1) with the database 150 (see FIG. 1) to offer the service B. In the request in step 11, information indicative of a period from the time t0 to the time t1 is given as an argument of a period.

Upon receipt of this request, the server 100 acquires the changed data from the database 150 (step 12).

In a case where a change is found in data of a corresponding user, the server 100 collects data changed during the period and returns the data to the client terminal 200 (step 13).

In the present exemplary embodiment, in a case where no change is found in data of the corresponding user, the server 100 may be configured not to return the data in actual operation. Alternatively, even in a case where no change is found in data of the corresponding user, the server 100 may be configured to return information indicating that no change has been made to the data to the client terminal 200 in actual operation.

Upon receipt of the data, the client terminal 200 reflects the received data in the database 250 (see FIG. 1) (step 14).

In the example illustrated in FIG. 6, the user terminal 30A instructs the server 100 to insert data (d1) before a next request for acquisition of data from the client terminal 200 to the server 100 (step 15).

Upon receipt of the instruction, the server 100 reflects the data (d1) in the database 150 (step 16). During communication using the synchronous API, the inserted data (d1) is not instantly reflected in the database 250.

When a predetermined period elapses from the time t1, the client terminal 200 requests the server 100 to acquire data changed between the time t1 and the time t2 (step 17).

The time t2 is a time at which the client terminal 200 transmits the request.

Upon receipt of this request, the server 100 acquires the changed data (d1) from the database 150 (step 18).

In a case where a change is found in data of the corresponding user, the server 100 collects data changed during the period and returns the data to the client terminal 200. In this example, the server 100 returns the data (d1) (step 19).

Upon receipt of the data, the client terminal 200 reflects the received data (d1) in the database 250 (step 20).

By thus reflecting the data, the database 150 of the server 100 and the database 250 of the client terminal 200 are synchronized with each other. As described above, in communication using the synchronous API, there is a time difference between reflection of the data (d1) in the database 150 and reflection of the data (d1) in the database 250. However, a load on the server 100 is smaller than that in a case where instantaneousness is requested.

Although a case where the data (d1) is inserted into the database 150 is illustrated in FIG. 6, similar processing operation is also performed in a case where data in the database 150 is updated or deleted.

### Communication Sequence Using Asynchronous API

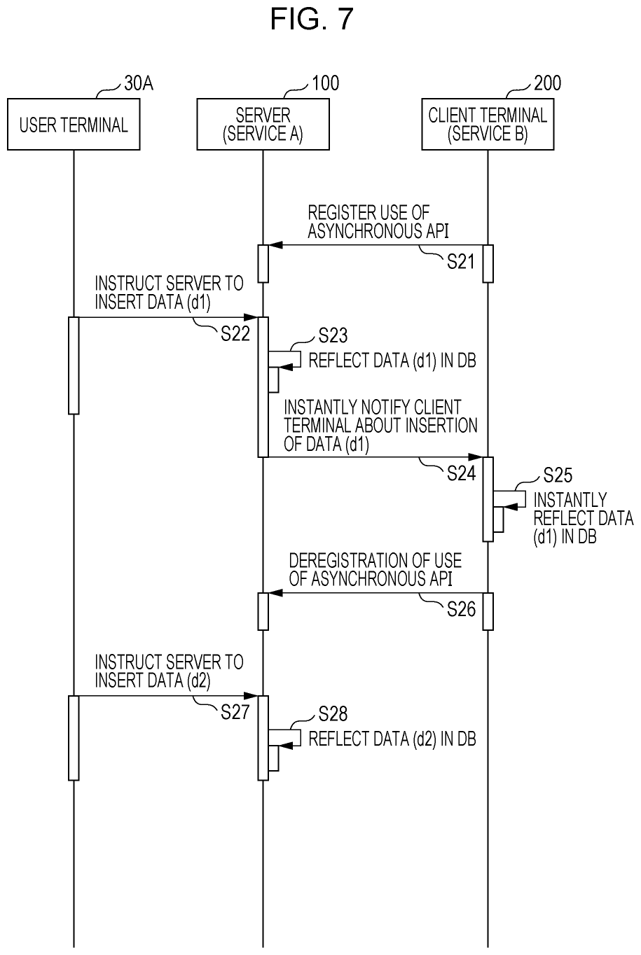

FIG. 7 is a view for explaining an example of a communication sequence using the asynchronous API. In FIG. 7, parts corresponding to those in FIG. 6 are given corresponding reference signs.

The communication sequence illustrated in FIG. 7 starts when the client terminal 200 registers use of the asynchronous API in the server 100 (step 21). This communication is performed in a case where the data flow rate is equal to or lower than the threshold value A (see FIG. 5) and user's use frequency is equal to or higher than the threshold value B (see FIG. 5).

As a result of the registration, the server 100 uses the asynchronous API for communication with the client terminal 200 of a corresponding user.

In FIG. 7, when the user terminal 30A instructs the server 100 to insert the data (d1) (step 22), the server 100 reflects the data (d1) in the database 150 (step 23). Furthermore, the server 100 instantly notifies the client terminal 200 about the insertion of the data (d1) (step 24). Upon receipt of the notification, the client terminal 200 instantly reflects the received data in the database 250 (see FIG. 1) (step 25).

FIG. 7 also illustrates a case where an event that switches the communication using the asynchronous API to communication using the synchronous API is detected by the client terminal 200.

In a case where an event that switches the communication using the asynchronous API to communication using the synchronous API is detected, the client terminal 200 notifies the server 100 about deregistration of use of the asynchronous API (step 26). Upon receipt of the notification about deregistration, the server 100 changes settings to use the synchronous API for communication with a corresponding user.

Accordingly, even in a case where the user terminal 30A instructs the server 100 to insert data (d2) (step 27), the server 100 merely reflects the data (d2) in the database 150 (step 28). That is, during communication using the synchronous API, the server 100 does not instantly notify the client terminal 200 about reflection of the data (d2) in the database 150.

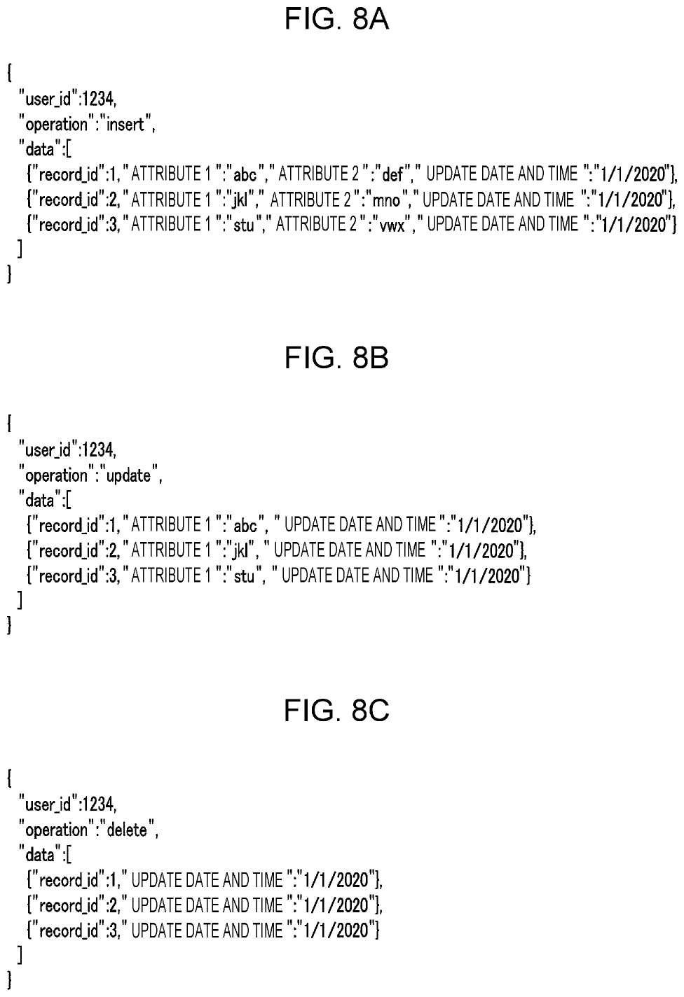

FIGS. 8A through 8C illustrate an example of description of data transmitted from the server 100 (see FIG.) to the client terminal 200 (see FIG. 1). FIG. 8A illustrates an example of data in a case where a change has been made by insertion of data, FIG. 8B illustrates an example of data in a case where a change has been made by update of data, and FIG. 8C illustrates an example of data in a case where a change has been made by deletion of data.

The data examples illustrated in FIGS. 8A through 8C are written in a JavaScript Object Notation (JSON) format.

In any data example, information for specifying a user is included. In FIGS. 8A through 8C, “1234” is written as a user ID. Furthermore, information indicative of the kind of change is included. In FIGS. 8A through 8C, this information is a character string that follows “operation”.

In a case of data insertion, data transmitted from the server 100 to the client terminal 200 includes a record ID indicative of an inserted position, update date and time, and all attributes after the insertion. Note that in a case where the client terminal 200 requests the server 100 to synchronize data, data excluding a row starting from “operation” is returned from the server 100 to the client terminal 200.

In a case of data update, data transmitted from the server 100 to the client terminal 200 includes only a record ID indicative of an updated position, update date and time, and an updated attribute.

In a case of data deletion, data transmitted from the server 100 to the client terminal 200 includes only a record ID indicative of a deleted position and update date and time. Communication Sequence After Switching to Synchronous API

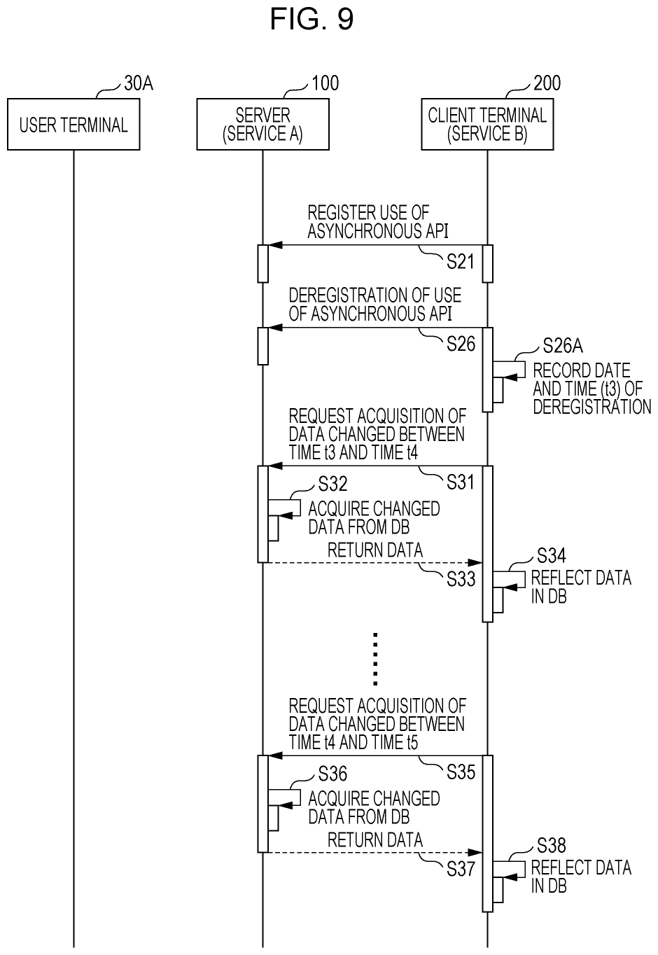

FIG. 9 is a view for explaining an example of a communication sequence after switching to the synchronous API. In FIG. 9, parts corresponding to those in FIG. 7 are given corresponding reference signs.

Part of the communication sequence illustrated in FIG. 9 is identical to part of the communication sequence illustrated in FIG. 7. Although a change occurs in the database 150 (see FIG. 1) of the server 100 between start of communication using the asynchronous API and switching to communication using the synchronous API in the communication sequence illustrated in FIG. 7, no change is made to the database 150 between step 21 and step 26 in FIG. 9.

In FIG. 9, the client terminal 200 that has notified the server 100 about deregistration of use of the asynchronous API records date and time (t3) of the deregistration (step 26A). Although step 26A is not illustrated in FIG. 7, step 26A is also actually executed in FIG. 7.

FIG. 9 illustrates a request for acquisition of data made by the client terminal 200 and return of data after the deregistration of use of the asynchronous API.

When a predetermined period elapses from the date and time (t3) of the deregistration, the client terminal 200 requests the server 100 to acquire data changed between the time t3 and a time t4 (step 31). The time t4 is a current time at which the client terminal 200 transmits the request.

Upon receipt of this request, the server 100 acquires data changed between the time t3 and the time t4 from the database 150 (step 32) and returns the data to the client terminal 200 (step 33). The client terminal 200 reflects the data returned from the server 100 in the database 250 (step 34). This synchronizes the database 250 with the database 150.

When a predetermined period elapses the time t4, the client terminal 200 requests the server 100 to acquire data changed between the time t4 and a time t5 (step 35). The time t5 is a current time at which the client terminal 200 transmits the request.

Upon receipt of this request, the server 100 acquires the data changed between the time t4 and the time t5 (step 36) and returns the data to the client terminal 200 (step 37). The client terminal 200 reflects the data returned from the server 100 in the database 250 (step 38). This synchronizes the database 250 with the database 150.

The above communication and processing operation are repeated. In FIG. 9, an instruction to change data given from the user terminal 30A to the server 100 is omitted. Communication Sequence Immediately After Switching to Asynchronous API

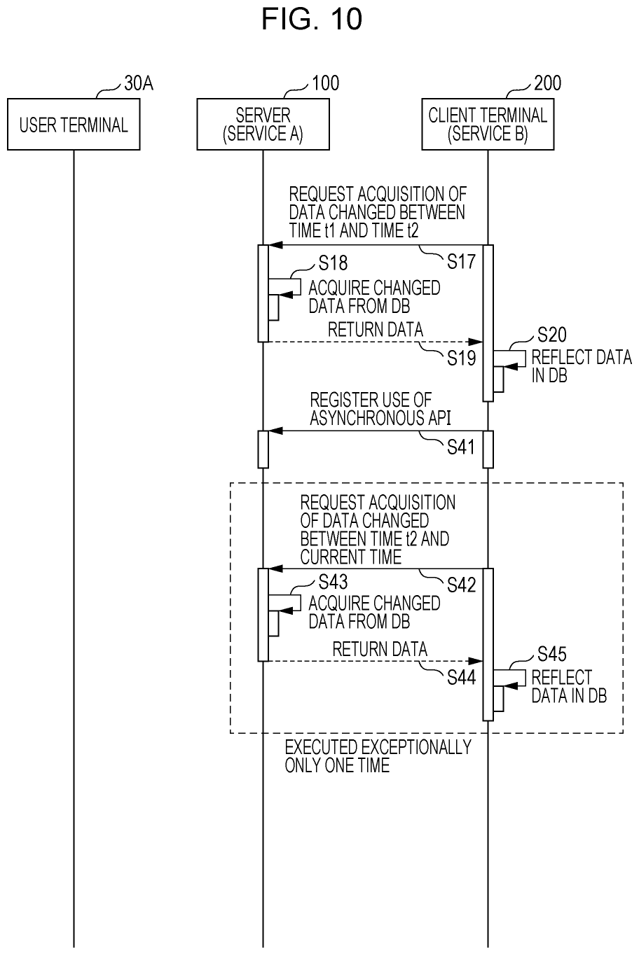

FIG. 10 is a view for explaining an example of a communication sequence immediately after switching to the asynchronous API. In FIG. 10, parts corresponding to those in FIG. 6 are given corresponding reference signs.

Part of the communication sequence illustrated in FIG. 10 is identical to part of the communication sequence illustrated in FIG. 6. Specifically, steps 17 to 20 are common to the communication sequence illustrated in FIG. 10 and the communication sequence illustrated in FIG. 6.

In FIG. 10, the client terminal 200 registers use of the asynchronous API in the server 100 after step 20 (step 41). The server 100 instantly notifies the client terminal 200 about a change of data that occurs after switching to the asynchronous API, but the client terminal 200 is not notified about a change of data that occurs between the time t2 and the switching to the asynchronous API.

In view of this, the client terminal 200 requests acquisition of data changed between the time t2 to a current time (step 42). Note that the period to the current time is designated because the client terminal 200 cannot know a time of registration of use of the asynchronous API by the server 100.

Upon receipt of this request, the server 100 acquires data changed between the time t2 and the current time from the database 150 (step 43) and returns the data to the client terminal 200 (step 44). The client terminal 200 reflects the data returned from the server 100 in the database 250 (step 45). Steps 42 to 45 surrounded by the broken line in FIG. 10 are executed exceptionally only one time immediately after switching to communication using the asynchronous API.

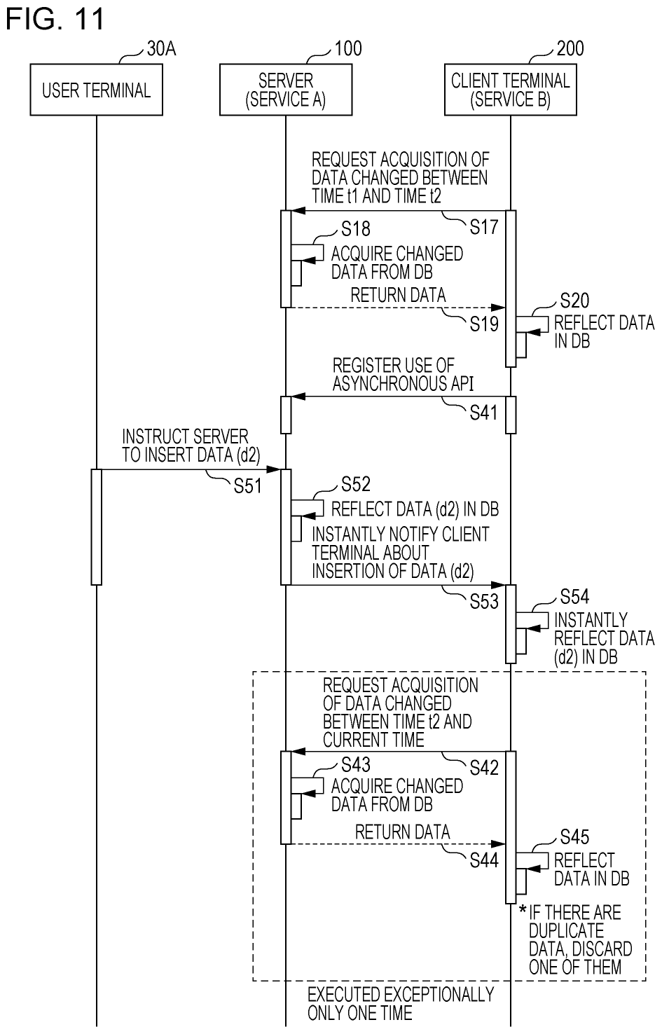

FIG. 11 is a view for explaining another example of the communication sequence immediately after switching to the asynchronous API. In FIG. 11, parts corresponding to those in FIG. 10 are given corresponding reference signs.

FIG. 11 illustrates a case where a change occurs in data in the database 150 (see FIG. 1) between a time at which the server 100 switches communication to the asynchronous API and a time at which the server 100 is notified about the request in step 42.

In FIG. 11, the user terminal 30A instructs the server 100 to insert data (d2) between step 41 and step 42 (step 51).

Accordingly, the server 100 reflects the data (d2) in the database 150 (step 52) and instantly notifies the client terminal 200 about the insertion of the data (d2) (step 53). Upon receipt of the notification, the client terminal 200 instantly reflects the received data in the database 250 (see FIG. 1) (step 54).

In FIG. 11, steps 42 to 45 are executed after step 54. Accordingly, there is a possibility that the same data (d2) is reflected in the database 250.

In view of this, in a case where the database 250 has the same data as data returned in response to a request for acquisition of data made immediately after switching to the asynchronous API, the client terminal 200 determines whether these pieces of data match each other by referring to update dates and times of these pieces of data.

In a case where the update dates and times are different, the client terminal 200 updates the database 250 with the data (d2) of the latest update date and time.

Meanwhile, in a case where the update dates and times are the same, the client terminal 200 discards the data (d2) acquired in step 44.

### Second Exemplary Embodiment

In the present exemplary embodiment, a case where switching of an API is determined by a method different from the first exemplary embodiment is described. In the present exemplary embodiment, an asynchronous API is used for communication of all users in principle. Accordingly, a change of a database 150 (see FIG. 1) is instantly reflected in a database 250 (see FIG. 1).

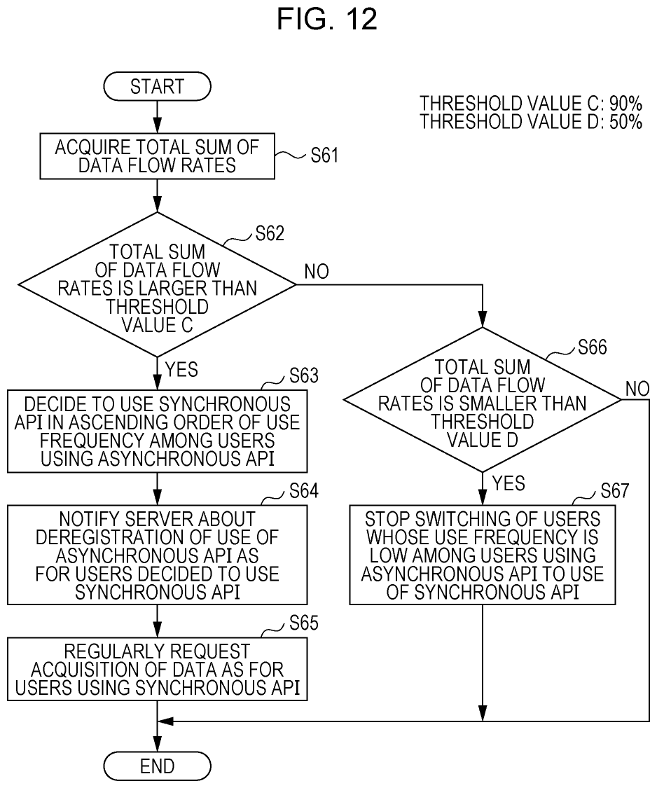

FIG. 12 is a flowchart for explaining an example of processing operation of a user API determining unit 201C (see FIG. 4) used in the second exemplary embodiment. In FIG. 12, the symbol “S” represents a step.

The user API determining unit 201C according to the present exemplary embodiment determines necessity of switching of an API as a whole system on the basis of a total sum of data flow rates and use frequencies of users. Note that information on a use frequency is used to decide a user for whom an API is to be switched.

First, the user API determining unit 201C acquires a total sum of data flow rates (step 61). The total sum of data flow rates may be, for example, a measured value of a flow rate of whole communication or may be, for example, a total sum of measured values of flow rates measured for the respective users. The total sum of data flow rates is an example of information on data flow rates of all users.

Next, the user API determining unit 201C determines whether or not the total sum of data flow rates is larger than a threshold value C (step 62). The threshold value C is an example of a second threshold value. The threshold value C gives an upper-limit value among plural threshold values used in the present exemplary embodiment. Accordingly, the threshold value C is also referred to as an upper-limit threshold value. In the present exemplary embodiment, the threshold value C is set to 90% of a communication bandwidth.

In a case where the total sum of data flow rates is larger than the upper-limit threshold value, the user API determining unit 201C obtains a positive result in step 62. This case corresponds to a state where a communication bandwidth allocated to communication from a server 100 (see FIG. 1) to a client terminal 200 (see FIG. 1) is tight.

In a case where a positive result is obtained in step 62, the user API determining unit 201C decides to use a synchronous API for users selected in ascending order of use frequency from among users using the asynchronous API (step 63). That is, a reduction in load is attempted.

Next, the user API determining unit 201C notifies the server 100 about deregistration of use of the asynchronous API as for the selected users (step 64). This notification is continued until the total sum of data flow rates becomes equal to or smaller than the threshold value C.

Further, the user API determining unit 201C regularly requests acquisition of data as for the users using the synchronous API (step 65).

Meanwhile, in a case where the total sum of data flow rates is equal to or smaller than the upper-limit threshold value, the user API determining unit 201C obtains a negative result in step 62. This case corresponds to a state where the communication bandwidth allocated to communication from the server 100 to the client terminal 200 is not tight.

In a case where a negative result is obtained in step 62, the user API determining unit 201C determines whether or not the total sum of data flow rates is smaller than a threshold value D (step 66). The threshold value D is an example of a third threshold value. The threshold value D gives an intermediate value among the plural threshold values used in the present exemplary embodiment. Accordingly, the threshold value D is also referred to as an intermediate threshold value. In the present exemplary embodiment, the threshold value D is set to 50% of the communication bandwidth.

In a case where the total sum of data flow rates is smaller than the intermediate threshold value, the user API determining unit 201C obtains a positive result in step 66. This case corresponds to a state where there is an enough room in the communication bandwidth allocated to communication from the server 100 to the client terminal 200.

In a case where a positive result is obtained in step 66, the user API determining unit 201C stops switching of a user whose use frequency is low among the users using the asynchronous API to use of the synchronous API (step 67).

Meanwhile, in a case where the total sum of data flow rates falls within a range between the upper-limit threshold value and the intermediate threshold value, the user API determining unit 201C obtains a negative result in step 66. In this case, the user API determining unit 201C maintains methods currently used by the users. That is, the user API determining unit 201C maintains APIs used for communication by the users.

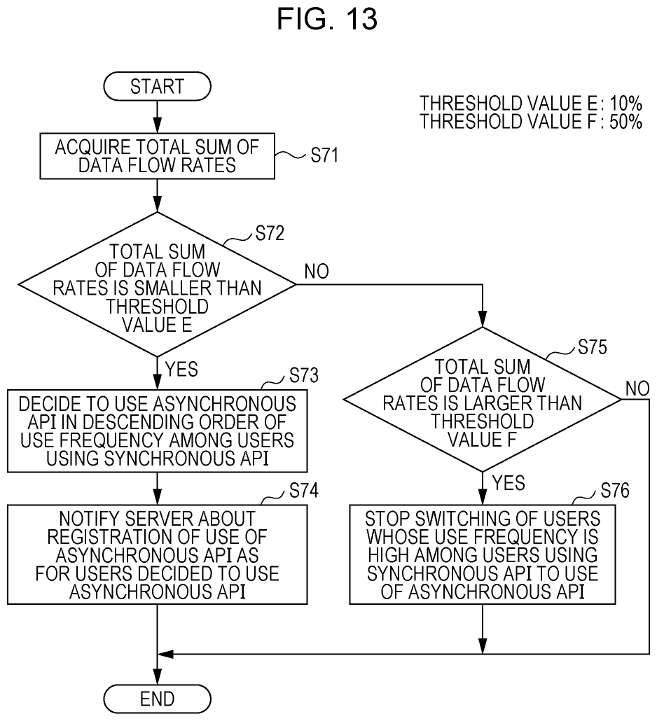

FIG. 13 is a flowchart for explaining another example of processing operation of the user API determining unit 201C (see FIG. 4) used in the second exemplary embodiment.

In the processing operation illustrated in FIG. 13, it is assumed that the total sum of data flow rates is small.

First, the user API determining unit 201C acquires a total sum of data flow rates (step 71).

Next, the user API determining unit 201C determines whether or not the total sum of data flow rates is smaller than a threshold value E (step 72). The threshold value E is an example of a fourth threshold value. The threshold value E gives a low-limit value among the plural threshold values used in the present exemplary embodiment. Accordingly, the threshold value E is also referred to as a low-limit threshold value. In the present exemplary embodiment, the threshold value E is set to 10% of the communication bandwidth.

In a case where the total sum of data flow rates is smaller than the lower-limit threshold value, the user API determining unit 201C obtains a positive result in step 72. This case corresponds to a state where a load on the server 100 (see FIG. 1) is small.

In a case where a positive result is obtained in step 72, the user API determining unit 201C decides to use the asynchronous API for users selected in descending order of use frequency from among users using the synchronous API (step 73). This improves instantaneousness.

Next, the user API determining unit 201C notifies the server 100 about registration of use of the asynchronous API as for the selected users (step 74). This notification continues until the total sum of data flow rates becomes equal to or larger than the threshold value E.

In a case where the total sum of data flow rates is smaller than the intermediate threshold value and is equal to or larger than the lower-limit threshold value, the user API determining unit 201C obtains a negative result in step 72.

In a case where a negative result is obtained in step 72, the user API determining unit 201C determines whether or not the total sum of data flow rates is larger than a threshold value F (step 75). The threshold value F also gives an intermediate value among the plural threshold values used in the present exemplary embodiment. Accordingly, the threshold value F is also referred to as an intermediate threshold value. In the present exemplary embodiment, the threshold value F is set to 50% of the communication bandwidth. Although the threshold value F is distinguished from the threshold value D (see FIG. 12) in the present exemplary embodiment, the threshold value F may be the same as the threshold value D.

In a case where the total sum of data flow rates is equal to or smaller than the threshold value F, which is the intermediate threshold value, the user API determining unit 201C obtains a negative result in step 75. In this case, the user API determining unit 201C maintains methods currently used by the users. That is, the user API determining unit 201C maintains APIs used for communication by the users.

Meanwhile, in a case where the total sum of data flow rates is larger than the threshold value F, which is the intermediate threshold value, the user API determining unit 201C obtains a positive result in step 75. In this case, the user API determining unit 201C stops switching of users of high use frequency among users using the synchronous API to use of the asynchronous API (step 76).

### Third Exemplary Embodiment

Also in the present exemplary embodiment, a case where switching of an API is determined by a method different from the method of the first exemplary embodiment is described. Also in the present exemplary embodiment, an asynchronous API is used for communication of all users in principle. Accordingly, a change to a database 150 (see FIG. 1) is instantly reflected in a database 250 (see FIG. 1).

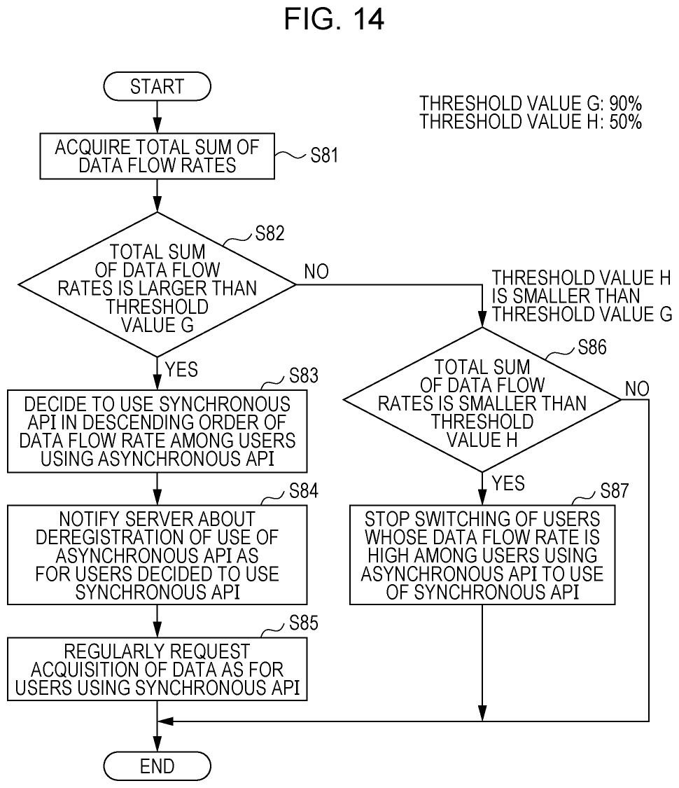

FIG. 14 is a flowchart for explaining an example of processing operation of a user API determining unit 201C (see FIG. 4) used in the third exemplary embodiment. In FIG. 14, the symbol “S” represents a step.

The user API determining unit 201C according to the present exemplary embodiment determines necessity of switching of an API as a whole system on the basis of a total sum of data flow rates and a data flow rate of each user. Note that information on a data flow rate is used to decide a user for whom an API is to be switched.

An API used for communication of each user is decided.

First, the user API determining unit 201C acquires a total sum of data flow rates (step 81).

Next, the user API determining unit 201C determines whether or not the total sum of data flow rates is larger than a threshold value G (step 82). The threshold value G is an example of a second threshold value. The threshold value G gives an upper-limit value among plural threshold values used in the present exemplary embodiment. Accordingly, the threshold value G is also referred to as an upper-limit threshold value. In the present exemplary embodiment, the threshold value G is set to 90% of a communication bandwidth.

In a case where the total sum of data flow rates is larger than the upper-limit threshold value, the user API determining unit 201C obtains a positive result in step 82. This case corresponds to a state where a communication bandwidth allocated to communication from a server 100 (see FIG. 1) to a client terminal 200 (see FIG. 1) is tight.

In a case where a positive result is obtained in step 62, the user API determining unit 201C decides to use a synchronous API for users selected in descending order of data flow rate from among users using the asynchronous API (step 83). That is, a reduction in load is attempted.

Next, the user API determining unit 201C notifies the server 100 about deregistration of use of the asynchronous API as for the selected users (step 84). This notification continues until the total sum of data flow rates becomes equal to or smaller than the threshold value G.

Further, the user API determining unit 201C regularly requests acquisition of data as for the users using the synchronous API (step 85).

Meanwhile, in a case where the total sum of data flow rates is equal to or smaller than the upper-limit threshold value, the user API determining unit 201C obtains a negative result in step 82. This case corresponds to a state where the communication bandwidth allocated to communication from the server 100 to the client terminal 200 is not tight.

In a case where a negative result is obtained in step 82, the user API determining unit 201C determines whether or not the total sum of data flow rates is smaller than a threshold value H (step 86). The threshold value H is an example of a fifth threshold value. The threshold value H gives an intermediate value among the plural threshold values used in the present exemplary embodiment. Accordingly, the threshold value H is also referred to as an intermediate threshold value. In the present exemplary embodiment, the threshold value H is set to 50% of the communication bandwidth.

In a case where the total sum of data flow rates is smaller than the intermediate threshold value, the user API determining unit 201C obtains a positive result in step 86. This case corresponds to a state where there is an enough room in communication bandwidth allocated to communication from the server 100 to the client terminal 200.

In a case where a positive result is obtained in step 86, the user API determining unit 201C stops switching of users whose data flow rate is high among users using the asynchronous API to use of the synchronous API (step 87).

Meanwhile, in a case where the total sum of data flow rates falls within a range between the upper-limit threshold value and the intermediate threshold value, the user API determining unit 201C obtains a negative result in step 86. In this case, the user API determining unit 201C maintains methods currently used by users. That is, the user API determining unit 201C maintains APIs used for communication by the users.

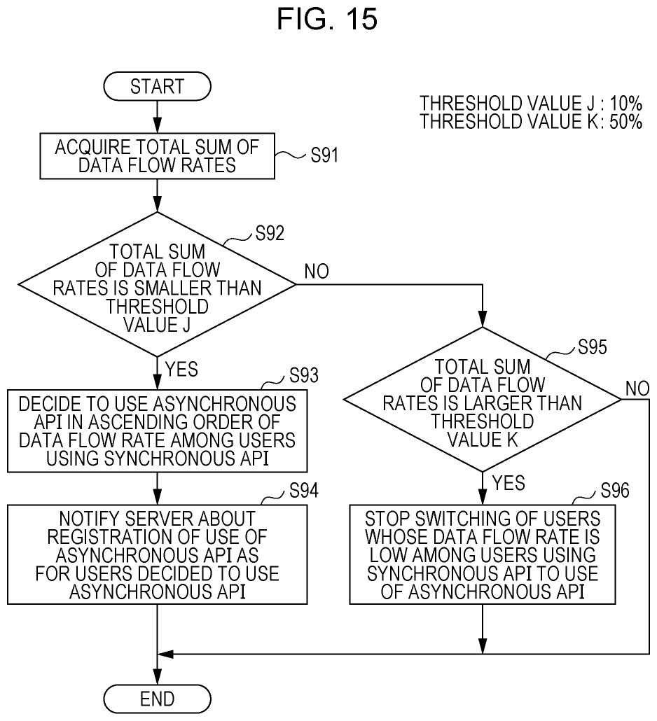

FIG. 15 is a flowchart for explaining another example of processing operation of the user API determining unit 201C (see FIG. 4) used in the third exemplary embodiment.

In the processing operation illustrated in FIG. 15, it is assumed that the total sum of data flow rates is small.

First, the user API determining unit 201C acquires a total sum of data flow rates (step 91).

Next, the user API determining unit 201C determines whether or not the total sum of data flow rates is smaller than a threshold value J (step 92). The threshold value J is an example of a sixth threshold value. The threshold value J gives a lower-limit value among the plural threshold values used in the present exemplary embodiment. Accordingly, the threshold value J is also referred to as a lower-limit threshold value. In the present exemplary embodiment, the threshold value J is set to 10% of the communication bandwidth.

In a case where the total sum of data flow rates is lower than the lower-limit threshold value, the user API determining unit 201C obtains a positive result in step 92. This case corresponds to a state where a load on the server 100 (see FIG. 1) is small.

In a case where a positive result is obtained in step 92, the user API determining unit 201C decides to use the asynchronous API for users selected in ascending order of data flow rate from among users using the synchronous API (step 93). This improves instantaneousness.

Next, the user API determining unit 201C notifies the server 100 about registration of use of the asynchronous API as for the selected users (step 94). This notification continues until the total sum of data flow rates becomes equal to or larger than the threshold value J.

In a case where the total sum of data flow rates is smaller than the intermediate threshold value and is equal to or larger than the lower-limit threshold value, the user API determining unit 201C obtains a negative result in step 92.

In a case where a negative result is obtained in step 92, the user API determining unit 201C determines whether or not the total sum of data flow rates is larger than a threshold value K (step 95). The threshold value K also gives an intermediate value among the plural threshold values used in the present exemplary embodiment. Accordingly, the threshold value K is also referred to as an intermediate threshold value. In the present exemplary embodiment, the threshold value K is set to 50% of the communication bandwidth. Although the threshold value K is distinguished from the threshold value H (see FIG. 14) in the present exemplary embodiment, the threshold value K may be the same as the threshold value H.

In a case where the total sum of data flow rates is equal to or smaller than the threshold value K, which is the intermediate threshold value, the user API determining unit 201C obtains a negative result in step 95. In this case, the user API determining unit 201C maintains methods currently used by the users. That is, the user API determining unit 201C maintains APIs used for communication by the users.

Meanwhile, in a case where the total sum of data flow rates is larger than the threshold value K, which is the intermediate threshold value, the user API determining unit 201C obtains a positive result in step 95. In this case, the user API determining unit 201C stops switching of users whose data flow rate is low among the users using the synchronous API to use of the asynchronous API (step 96).

### Fourth Exemplary Embodiment

Also in the present exemplary embodiment, a case where switching of an API is determined by a method different from the first exemplary embodiment is described. Also in the present exemplary embodiment, an asynchronous API is used for communication of all users in principle. Accordingly, a change to a database 150 (see FIG. 1) is instantly reflected in a database 250 (see FIG. 1).

A method described in the present exemplary embodiment is a method combining the method described in the second exemplary embodiment and the method described in the third exemplary embodiment. Specifically, a user whose data flow rate is larger tends to be switched from an asynchronous API to a synchronous API more, and a user whose use frequency is lower tends to be switched from the asynchronous API to the synchronous API more.

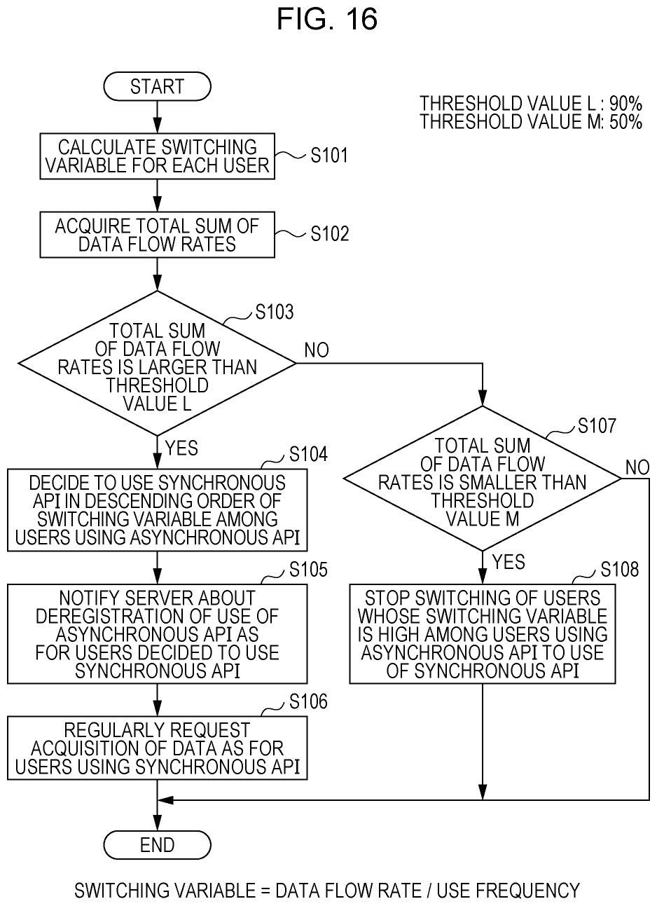

FIG. 16 is a flowchart for explaining an example of processing operation of a user API determining unit 201C (see FIG. 4) used in the fourth exemplary embodiment. In FIG. 16, the symbol “S” represents a step.

First, the user API determining unit 201C calculates a switching variable for each user (step 101).

In the present exemplary embodiment, the switching variable for each user is calculated as follows:

switching variable=data flow rate/use frequency formula 1.

In the formula, the denominator and the numerator are values measured for the same user.

Next, the user API determining unit 201C acquires a total sum of data flow rates (step 102).

Next, the user API determining unit 201C determines whether or not the total sum of data flow rates is larger than a threshold value L (step 103). The threshold value L gives an upper-limit value among plural threshold values used in the present exemplary embodiment. Accordingly, the threshold value L is also referred to as an upper-limit threshold value. In the present exemplary embodiment, the threshold value L is set to 90% of a communication bandwidth.

In a case where the total sum of data flow rates is larger than the upper-limit threshold value, the user API determining unit 201C obtains a positive result in step 103. This case corresponds to a state where a communication bandwidth allocated to communication from a server 100 (see FIG. 1) to a client terminal 200 (see FIG. 1) is tight.

In a case where a positive result is obtained in step 103, the user API determining unit 201C decides to use the synchronous API for users selected in descending order of switching variable from among users using the asynchronous API (step 104). That is, a reduction is load is attempted.

A user whose data flow rate is higher tends to have a larger switching variable, and a user whose use frequency is lower tends to have a larger switching variable. Accordingly, among users having a same degree of use frequency, a user whose data flow rate is higher tends to be switched from the asynchronous API to the synchronous API more. Furthermore, among users having a same degree of data flow rate, a user whose use frequency is lower tends to be switched from the asynchronous API to the synchronous API more.

Next, the user API determining unit 201C notifies the server 100 about deregistration of use of the asynchronous API as for the selected users (step 105). This notification continues until the total sum of data flow rates becomes equal to or smaller than the threshold value L.

Furthermore, the user API determining unit 201C regularly requests acquisition of data as for the users using the synchronous API (step 106).

Meanwhile, in a case where the total sum of data flow rates is equal to or smaller than the upper-limit threshold value, the user API determining unit 201C obtains a negative result in step 103. This case corresponds to a state where the communication bandwidth allocated to communication from the server 100 to the client terminal 200 is not tight.

In a case where a negative result is obtained in step 103, the user API determining unit 201C determines whether or not the total sum of data flow rates is smaller than a threshold value M (step 107). The threshold value M gives an intermediate value among the plural threshold values used in the present exemplary embodiment. Accordingly, the threshold value M is also referred to as an intermediate threshold value. In the present exemplary embodiment, the threshold value M is set to 50% of the communication bandwidth.

In a case where the total sum of data flow rates is smaller than the intermediate threshold value, the user API determining unit 201C obtains a positive result in step 107. This case corresponds to a state where there is an enough room in the communication bandwidth allocated to communication from the server 100 to the client terminal 200.

In a case where a positive result is obtained in step 107, the user API determining unit 201C stops switching of users whose switching variable is large among the users using the asynchronous API to use of the synchronous API (step 108).

Meanwhile, in a case where the total sum of data flow rates falls within a range between the upper-limit threshold value and the intermediate threshold value, the user API determining unit 201C obtains a negative result in step 107. In this case, the user API determining unit 201C maintains methods currently used by the users. That is, the user API determining unit 201C maintains APIs used for communication by the users.

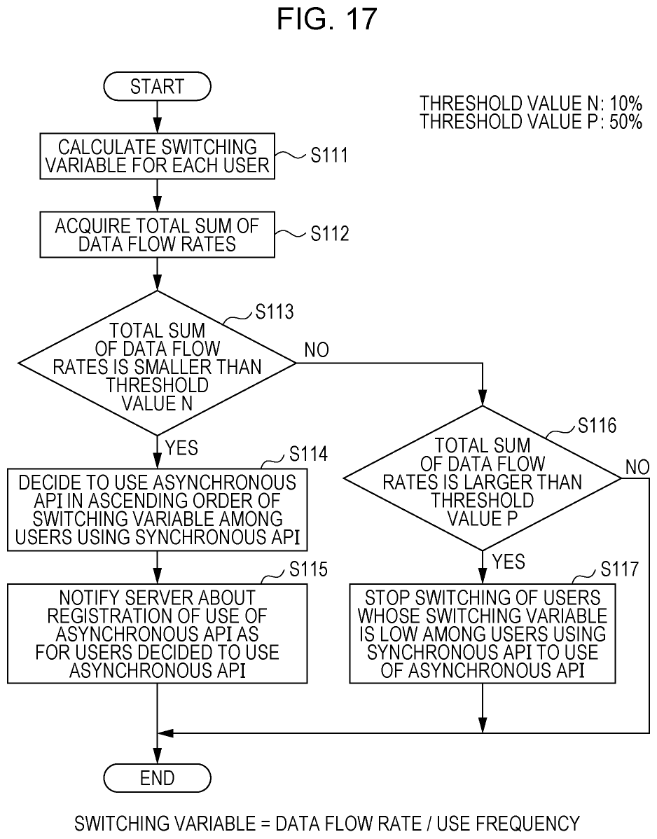

FIG. 17 is a flowchart for explaining another example of processing operation of the user API determining unit 201C (see FIG. 4) used in the fourth exemplary embodiment.

In the processing operation illustrated in FIG. 17, it is assumed that the total sum of data flow rates is small.

First, the user API determining unit 201C calculates a switching variable for each user as in step 101 (step 111). The switching variable is the same as the formula 1.

Next, the user API determining unit 201C acquires a total sum of data flow rates (step 112).

Next, the user API determining unit 201C determines whether or not the total sum of data flow rates is smaller than a threshold value N (step 113). The threshold value N gives a lower-limit value among the plural threshold values used in the present exemplary embodiment. Accordingly, the threshold value N is also referred to as a lower-limit threshold value. In the present exemplary embodiment, the threshold value N is set to 10% of the communication bandwidth.

In a case where the total sum of data flow rates is smaller than the lower-limit threshold value, the user API determining unit 201C obtains a positive result in step 113. This case corresponds to a case where a load on the server 100 (see FIG. 1) is small.

In a case where a positive result is obtained in step 113, the user API determining unit 201C decides to use the asynchronous API for users selected in ascending order of switching variable from among users using the synchronous API (step 114). This improves instantaneousness.

A user whose data flow rate is higher tends to have a larger switching variable, and a user whose use frequency is lower tends to have a larger switching variable. Accordingly, among users having a same degree of use frequency, a user whose data flow rate is lower tends to be switched from the synchronous API to the asynchronous API more. Furthermore, among users having a same degree of data flow rate, a user whose use frequency is higher tends to be switched from the synchronous API to the asynchronous API more.

Next, the user API determining unit 201C notifies the server 100 about registration of use of the asynchronous API as for the selected users (step 115). This notification continues until the total sum of data flow rates becomes equal to or larger than the threshold value N.

In a case where the total sum of data flow rates is smaller than the intermediate threshold value and is equal to or larger than the lower-limit threshold value, the user API determining unit 201C obtains a negative result in step 113.

In a case where a negative result is obtained in step 113, the user API determining unit 201C determines whether or not the total sum of data flow rates is larger than a threshold value P (step 116). The threshold value P gives an intermediate value among the plural threshold values used in the present exemplary embodiment. Accordingly, the threshold value P is also referred to as an intermediate threshold value. In the present exemplary embodiment, the threshold value P is set to 50% of the communication bandwidth. Although the threshold value P is distinguished from the threshold value M (see FIG. 16) in the present exemplary embodiment, the threshold value P may be the same as the threshold value M.

In a case where the total sum of data flow rates is equal to or smaller than the threshold value P, which is the intermediate threshold value, the user API determining unit 201C obtains a negative result in step 116. In this case, the user API determining unit 201C maintains methods currently used by the users. That is, the user API determining unit 201C maintains APIs used for communication by the users.

Meanwhile, in a case where the total sum of data flow rates is larger than the threshold value P, which is the intermediate threshold value, the user API determining unit 201C obtains a positive result in step 116. In this case, the user API determining unit 201C stops switching of users whose switching variable is small among users using the synchronous API to use of the asynchronous API (step 117).

### Other Exemplary Embodiments

Although the exemplary embodiments of the present disclosure have been described above, the technical scope of the present disclosure is not limited to the scope described in the above exemplary embodiments. It is apparent from the claims that various changes or modifications of the above exemplary embodiments are also encompassed within the technical scope of the present disclosure.

Although for example, an API used for communication of a user for whom a positive result is obtained in step 1 (see FIG. 5) or a user for whom a positive result is obtained in step 2 (see FIG. 5) is switched from the asynchronous API to the synchronous API in the above exemplary embodiments, communication of a user different from this user may be switched from the asynchronous API to the synchronous API. Similarly, communication of a user different from a user for whom a positive result is obtained in step 6 (see FIG. 1) may be switched from the synchronous API to the asynchronous API.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to switch a communication interface used for communication with a communication partner, in which data to be acquired is stored, in accordance with a state of the information processing apparatus in a case where a first communication interface, which is an asynchronous communication interface that notifies the information processing apparatus about a change made to the data every time the data is changed, and a second communication interface, which is a synchronous communication interface that collectively notifies the information processing apparatus about a plurality of changes made to the data, are prepared in the communication partner.

2. The information processing apparatus according to claim 1, wherein
the processor is configured to control switching of the communication interface on a basis of a data flow rate at which data flows from the communication partner into the information processing apparatus.

3. The information processing apparatus according to claim 2, wherein
the processor is configured to monitor the data flow rate for each user and use the second communication interface for communication of a user whose data flow rate is higher than a first threshold value.

4. The information processing apparatus according to claim 2, wherein
the processor is configured to monitor the data flow rate for each user and, upon detection of a user whose data flow rate is higher than a first threshold value, switches communication of another user from the first communication interface to the second communication interface.

5. The information processing apparatus according to claim 2, wherein
the processor is configured to monitor the data flow rate of whole communication of a plurality of users, and in a case where the data flow rate becomes larger than a second threshold value, use the second communication interface for communication of a user whose frequency of use of the information processing apparatus is relatively low.

6. The information processing apparatus according to claim 5, wherein
the processor is configured to decide a user to be switched from the first communication interface to the second communication interface in ascending order of frequency of use of the information processing apparatus.

7. The information processing apparatus according to claim 5, wherein
the processor is configured to stop the switching from the first communication interface to the second communication interface in a case where the date flow rate becomes lower than a third threshold value, which is smaller than the second threshold value.

8. The information processing apparatus according to claim 5, wherein
the processor is configured to use the first communication interface for communication of a user whose frequency of use of the information processing apparatus is relatively high among users who are using the second communication interface for communication in a case where the data flow rate becomes lower than a fourth threshold value, which is smaller than the second threshold value.

9. The information processing apparatus according to claim 8, wherein
the processor is configured to decide a user to be switched from the second communication interface to the first communication interface in descending order of frequency of use of the information processing apparatus.

10. The information processing apparatus according to claim 2, wherein
the processor is configured to monitor the data flow rate of whole communication of a plurality of users and, in a case where the data flow rate becomes larger than a second threshold value, use the second communication interface for communication of a user whose data flow rate is relatively high.

11. The information processing apparatus according to claim 10, wherein
the processor is configured to decide a user to be switched from the first communication interface to the second communication interface in descending order of user's individual data flow rate.

12. The information processing apparatus according to claim 11, wherein
the processor is configured to stop the switching of the communication interface used for communication of a user whose data flow rate is high in a case where the data flow rate of the whole communication becomes lower than a fifth threshold value, which is smaller than the second threshold value.

13. The information processing apparatus according to claim 10, wherein
the processor is configured to use the first communication interface for communication of a user whose data flow rate is relatively low among users who are using the second communication interface for communication in a case where the data flow rate becomes lower than a sixth threshold value.

14. The information processing apparatus according to claim 13, wherein
the processor is configured to decide a user to be switched from the second communication interface to the first communication interface in ascending order of data flow rate.

15. The information processing apparatus according to claim 1, wherein
the processor is configured to control switching of the communication interface on a basis of a user's frequency of use of the information processing apparatus per unit time.

16. The information processing apparatus according to claim 15, wherein
the processor is configured to monitor the frequency of use for each user and use the second communication interface for communication of a user whose frequency of use is lower than a seventh threshold value.

17. A non-transitory computer readable medium storing a program causing a computer to execute a process for information processing, the process comprising:
switching a communication interface used for communication with a communication partner, in which data to be acquired is stored, in accordance with a state of the computer in a case where a first communication interface, which is an asynchronous communication interface that notifies the computer about a change made to the data every time the data is changed, and a second communication interface, which is a synchronous communication interface that collectively notifies the computer about a plurality of changes made to the data, are prepared in the communication partner.

18. An information processing apparatus comprising:
means for switching a communication interface used for communication with a communication partner, in which data to be acquired is stored, in accordance with a state of the information processing apparatus in a case where a first communication interface, which is an asynchronous communication interface that notifies the information processing apparatus about a change made to the data every time the data is changed, and a second communication interface, which is a synchronous communication interface that collectively notifies the information processing apparatus about a plurality of changes made to the data, are prepared in the communication partner.
